(19) United States
(12) Patent Application Publication
(10) Pub. No.: US 2018/0245715 A1
(43) Pub. Date: Aug. 30, 2018

(54) Adjustable Truss Pick

(71) Applicant: Entertainment Structural Products, Inc., Essington, PA (US)

(72) Inventor: Michael P. A. Chouinard, Swarthmore, PA (US)

(73) Assignee: Entertainment Structural Products, Inc.

(21) Appl. No.: 15/880,792

(22) Filed: Jan. 26, 2018

Related U.S. Application Data
(60) Provisional application No. 62/463,377, filed on Feb. 24, 2017.

(51) Int. Cl. F16L 3/10; F16B 7/04; E04C 3/04; F16L 3/223

(52) U.S. Cl. CPC F16L 3/1075; F16B 7/0433; E04C 2003/026; F16L 3/2235; E04C 3/04

(57) ABSTRACT

The present invention relates to the field of hanging tubular space frame truss (“truss”) using truss picks. Truss units include tubular longitudinal truss chords, and tubular webbing elements interconnecting the truss chords. Truss picks attach to truss via the truss chords. Prior art truss picks were rigid and therefore incapable of adjusting attachment locations to account for variations in truss chord spacing. The invention described herein provides an adjustable truss pick having a swiveling saddle and clamp assembly that, as a result, creates adjustable spacing of truss pick attachment locations long desired in this field.

### RELATED APPLICATION INFORMATION

This application claims the benefit of and priority from U.S. provisional application Ser. No. 62/463,377, filed Feb. 24, 2017, all of the disclosures of which are incorporated herein by reference.

### BACKGROUND OF THE INVENTION

The present invention relates to the field of hanging tubular space frame truss using a truss pick. There is a need in the construction and entertainment industries for a truss pick that is adjustable so as to be capable of hanging units of tubular space frame truss that vary in sizes.

### BRIEF SUMMARY OF THE INVENTION

Units of tubular space frame truss (“truss”) are used to suspend objects, often relatively heavy objects, above the ground. Truss units are commonly used, for example, in the entertainment industry to suspend lighting, speakers, video screens, and other entertainment equipment above stages or seating areas in entertainment venues. Truss units are also commonly used for various non-entertainment purposes such as for suspending displays above the ground at trade shows or conferences.

Rigging systems using truss are often temporary in nature. They are erected, and then a short time later, torn down, transported to a different venue, and then rebuilt.

Truss includes various sized, usually metal, tubular elements. The longitudinal tubular elements of a truss unit are called truss chords. Truss chords can be of various diameters. The distance between adjacent truss chords may differ as well.

Truss chords, in turn, are connected to each other by tubular webbing elements. Webbing elements also can be of various diameters and sizes.

A truss unit is an assembly of two or more truss chords together with the webbing elements that interconnect the truss chords. A unit of truss unit can have different numbers (two or more) or different arrangements (cross-sectional orientations) of truss chords. For example, a triangular truss typically has three truss chords oriented in a triangular cross-sectional arrangement. Box truss units typically have four truss chords oriented in a rectangular cross-sectional arrangement. As previously described, the truss chords of the truss units, regardless of cross-sectional arrangement, are interconnected by webbing elements, giving the truss unit form, strength, and stability. Because truss units, if constructed and suspended correctly, are strong and stable, they are useful for suspending heavy equipment or objects above the ground.

One piece of equipment that is used to suspend truss (and the equipment attached to the truss) above the ground is called a truss pick. In order to suspend a unit of truss, at least one, and usually more than one, truss picks are utilized, with each truss pick being attached, typically, to two or more truss chords of the truss unit. The truss picks need to be attached to the truss chords in a secure manner, in order to prevent the truss chords (and the equipment attached to the truss) from slipping or shifting while attached to the truss pick. Each truss pick, in turn, is attached directly or indirectly to, commonly, a vertical tension member, such as a chain, cable, rod, or the like, with that tension member itself being secured to a fixture, such as a permanent fixture, for example, a ceiling support structure.

In order to attach each truss pick to its respective vertical tension member, one or more attachment systems known in the art may be used. For example, if the vertical tension member is a chain, an indirect attachment system could be used to attach the truss pick. For example, a U-shaped shackle might be attached to the truss pick in one or more manners known in the art. The shackle could then be attached to the chain using one or more commonly known techniques. Other indirect attachment systems, such as hooks attached to chains (with the hook passing through a hole in the truss pick) are also known to the art. On the other hand, a direct connection system, such as a hole and pocket feature, could be incorporated in the truss pick for connecting the truss pick to a chain or other suitable tension member.

When the truss unit is attached securely to one or more truss picks, and the truss picks are attached securely to one or more vertical tension members (which are, in turn, attached to one or more secure fixtures, such as a ceiling support structure), then the weight load supported by the tubular space frame truss (e.g., the weight of the speakers, lights, video screens, and the truss itself) is carried through the bodies of the truss picks via the vertical tension members to the secure fixture to which the tension members are attached. It is important, for a truss pick to be effective, that the truss pick securely attach to the truss in order to prevent slipping or shifting between them, because, if slipping or shifting occurs, the load suspended from the truss, as well as the truss itself, could collapse.

A pervasive problem encountered by persons who erect rigging systems using truss and truss picks is consistently achieving a secure attachment between the truss picks and the truss. Ordinary truss picks are commonly made of rigid material. The distance between the attachment portions (commonly called “saddles” and “clamps”) of the prior art truss picks that attach to the truss chords of the truss are rigidly fixed. For any particular unit of truss, the distance between the truss chords to which the truss picks are attached are also fixed. Unless the distances between the saddles and clamps of the truss picks rather precisely match the distance between the truss chords for the unit of truss that is being attached to the truss pick, a proper and secure attachment between the truss pick and the truss cannot be achieved.

Adding to the problem, the distance between the truss chords in a truss unit of a particular nominal size and type made by a first manufacturer (e.g., a 12-inch triangular truss made by Manufacturer A) very often differs from the distance between the truss chords in a truss of the same nominal size and type made by a second, different manufacturer (e.g., a 12-inch triangular truss made by Manufacturer B). Thus, if an ordinary, rigid, prior art 12-inch truss pick having a fixed distance between attachment portions (such as saddles and clamps) is to be used for secure attachment to the trusses discussed above, it will often: (1) fit securely to the truss chords of Manufacturer A, but not Manufacturer B; (2) fit securely to the truss chords of Manufacturer B, but not Manufacturer A; or (3) not fit securely to the truss chords of either Manufacturer A or Manufacturer B. All three of these scenarios create problems for the erector of rigging that uses ordinary truss picks and units of truss.

Further compounding the problems of those who erect rigging systems using truss, even when multiple units of nominally identical truss is sourced from the same manufacturer (e.g., multiple units of 12-inch triangular truss, all made by Manufacturer C), the distance between truss chords in the different truss units may differ sufficiently so as to make secure attachment to the different units by a single truss pick (of a nominally correct size) difficult or even impossible. Stated another way, manufacturing techniques for truss often result in different units of truss having different distances between truss chords, even when those units are sourced from the same manufacturer and are, nominally, supposed to be the same size.

Thus, using prior art rigid truss picks, erectors of rigging systems using truss were left to their own devices in attempting to achieve a proper, secure attachment between a truss pick and truss. One “solution” was to have on hand a larger than required number of truss picks and truss units, often obtained from multiple sources, with the hope that somehow when the time came to build the next rigging system, a sufficient number of “close enough” matches could be found between some of the on-hand truss picks and truss units in order to achieve an acceptable number of sufficiently secure attachments. Another “solution” was to force-fit attachment between mis-matched truss picks and truss units. Still another “solution” was to attempt to bend the truss chords of the truss unit so that the truss chords fit more securely in the rigid prior art truss pick.

Each of the above “solutions” had substantial drawbacks. The first “solution,” having more parts on hand than necessary, and then hoping for a sufficient number of close enough matches between the truss picks and truss units, was expensive, time consuming, and often ineffective. When the hope of finding matches among the many parts proved futile, the erectors often resorted to the second and third “solutions,” which were often ineffective and potentially dangerous. They were frequently ineffective because trying to force or bend the truss chords of a truss to fit more exactly and securely with a rigid truss pick was often a futile exercise. Tubular space frame truss, by its very nature, is itself relatively strong and rigid. Bending truss chords, let alone bending them a rather precise amount using common tools, was extremely difficult. Moreover, if an erector were to succeed in bending the tubular metal of the truss chords, that could very well crimp, stress, or otherwise cause the material (usually metal) in the truss to be weakened, or to become locally stressed, or to introduce other flaws, and the result of a “successful” bending could ultimately be a rigging system failure.

Applicant's invention overcomes the problems of attaching truss units having different distances between truss chords to truss picks. Applicant does so by providing a unique feature in the Applicant's adjustable truss pick invention that permits an erector to vary the distance between the portions of the truss pick that attach to the truss chords of the truss units. Applicant's invention provides at least one adjustable first saddle and clamp assembly that is attached to the body of the adjustable truss pick in a manner that permits the adjustable first saddle and clamp assembly to swivel outwardly away from or inwardly toward the body of the truss. The truss pick includes a second saddle and clamp that may be integral with the body of the truss pick, and may therefore be stationary. As the adjustable first saddle and clamp assembly swivels away from the body of the adjustable truss pick invention, the distance increases between the portion of the adjustable first saddle and clamp assembly that attaches to a first truss chord of a truss unit, on the one hand, and the (in one described embodiment, stationary) portion of the second saddle and clamp assembly that attaches to a second truss chord of the same truss unit, on the other hand. Conversely, swiveling the adjustable first saddle and clamp assembly toward the body of the adjustable truss pick, the distance between the attachment portions of the truss pick decreases. When attaching Applicant's adjustable truss pick to adjacent truss chords of a unit of truss, an erector can easily and consistently achieve a proper, secure fit between the adjustable truss pick and the truss chords by causing the adjustable first saddle and clamp assembly to swivel in order to match the precise distance between the two adjacent truss chords, thus overcoming the problems discussed above relating to prior art, rigid truss picks.

### BRIEF DESCRIPTION OF THE DRAWINGS

FIG. 1 is a top front perspective view of the Adjustable Truss Pick of the present invention (from the side of the embodiment having the stationary second saddle and clamp assembly) showing one embodiment of the invention with both the adjustable first saddle and clamp assembly and the stationary second saddle and clamp assembly in their closed positions.

FIG. 2 is a front view of the Adjustable Truss Pick of the present invention showing the same embodiment of the invention as is illustrated in FIG. 1 with both the adjustable first saddle and clamp assembly and the stationary second saddle and clamp assembly in their closed positions.

FIG. 3 is a back view of the Adjustable Truss Pick of the present invention showing the same embodiment of the invention as is illustrated in FIG. 1 with both the adjustable first saddle and clamp assembly and the stationary second saddle and clamp assembly in their closed positions.

FIG. 4A is a top front perspective view of the Adjustable Truss Pick of the present invention showing the same embodiment of the invention as is illustrated in FIG. 1 (from the side of the embodiment having the adjustable first saddle and clamp assembly) with both the adjustable first saddle and clamp assembly and the stationary second saddle and clamp assembly in their closed positions, and illustrating where the magnified sectional view of section A of FIG. 4B is located.

FIG. 4B is a top front perspective view from the sectional left side of the Adjustable Truss Pick of the present invention showing the same embodiment of the invention as is illustrated in FIG. 1 (from the side of the embodiment having the adjustable first saddle and clamp assembly) with both the adjustable first saddle and clamp assembly and the stationary second saddle and clamp assembly in their closed positions, showing a magnified sectional view of section A from FIG. 4A.

FIG. 5A is a front view of the Adjustable Truss Pick of the present invention showing the same embodiment of the invention as is illustrated in FIG. 1 with both the adjustable first saddle and clamp assembly and the stationary second saddle and clamp assembly in their closed positions, illustrating the nature of the swiveling of the adjustable first saddle and clamp assembly that is available in the embodiment.

FIG. 5B is a front view of the Adjustable Truss Pick of the present invention showing the same embodiment of the invention as is illustrated in FIG. 1 with both the adjustable first saddle and clamp assembly and the stationary second saddle and clamp assembly in their closed positions, illustrating the innermost swivel position of the adjustable first saddle and clamp assembly, which defines the inner limit of the distance between the adjustable first saddle and clamp assembly and the stationary second saddle and clamp assembly.

FIG. 5C is a front view of the Adjustable Truss Pick of the present invention showing the same embodiment of the invention as is illustrated in FIG. 1 with both the adjustable first saddle and clamp assembly and the stationary second saddle and clamp assembly in their closed positions, illustrating the outermost swivel position of the adjustable first saddle and clamp assembly, which defines the outer limit of the distance between the adjustable first saddle and clamp assembly and the stationary second saddle and clamp assembly.

FIG. 6 is a side view of the Adjustable Truss Pick of the present invention showing the same embodiment of the invention as is illustrated in FIG. 1 (from the side of the embodiment having the adjustable first saddle and clamp assembly) with the adjustable first saddle and clamp assembly in its closed position.

### DETAILED DESCRIPTION OF THE INVENTION

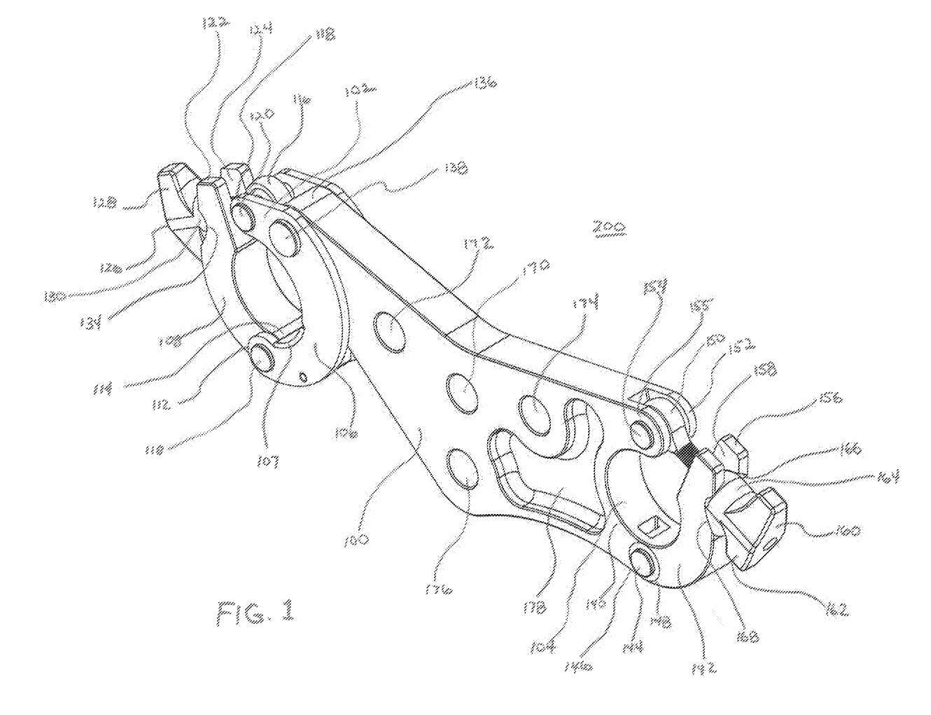

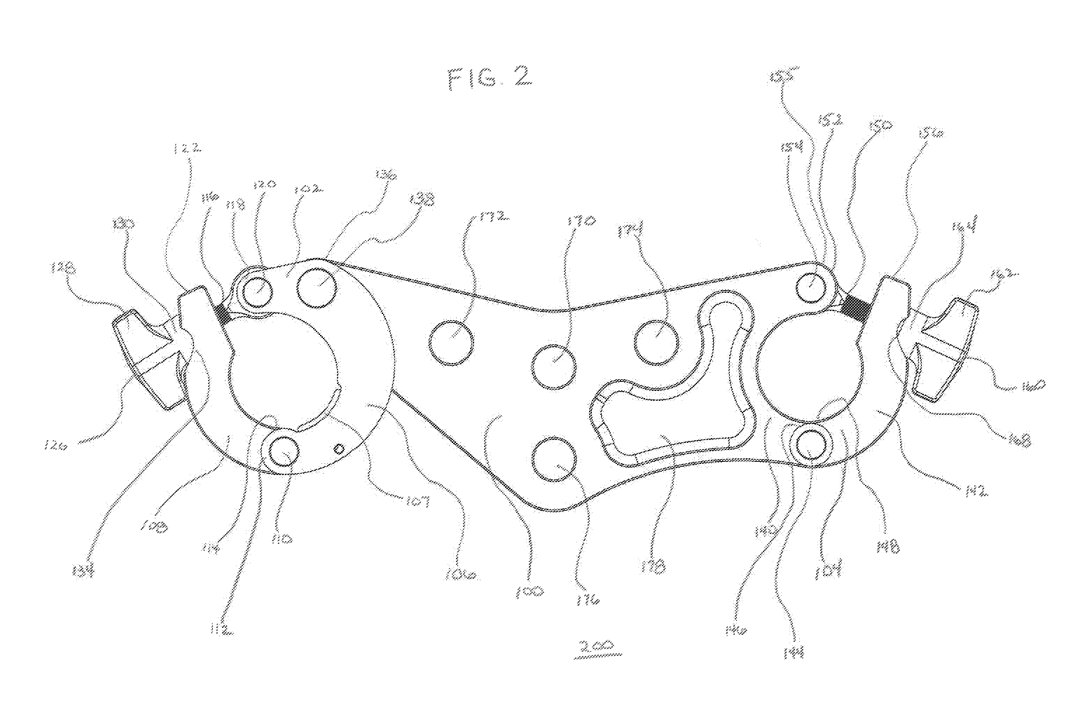

Referring first to FIGS. 1-3, 4A, and 4B, in one aspect of the invention, the adjustable truss pick 200 of the present invention includes a body 100, an adjustable first saddle and clamp assembly 102, and may include a stationary second saddle and clamp assembly 104.

The adjustable first saddle and clamp assembly 102 includes a first saddle 106 that has a generally semi-circular inner surface profile, as substantially defined by the inner surface of first saddle 106. First saddle support 107 is located on the lower inside surface of first saddle 106. First clamp 108 is also generally semi-circular in profile, as substantially defined by its inner surface. First saddle 106 is connected to first clamp 108 by first clamp post 110 near the distal end 112 of first saddle 106 and the proximal end 114 of first clamp 108. First clamp post 110 is sized so as to permit first clamp 108 to swivel relative to first saddle 106, and, in the illustrated embodiment, extends through the distal end 112 of first saddle 106 as well as the proximal end 114 of first clamp 108, securing them in a swiveling relationship.

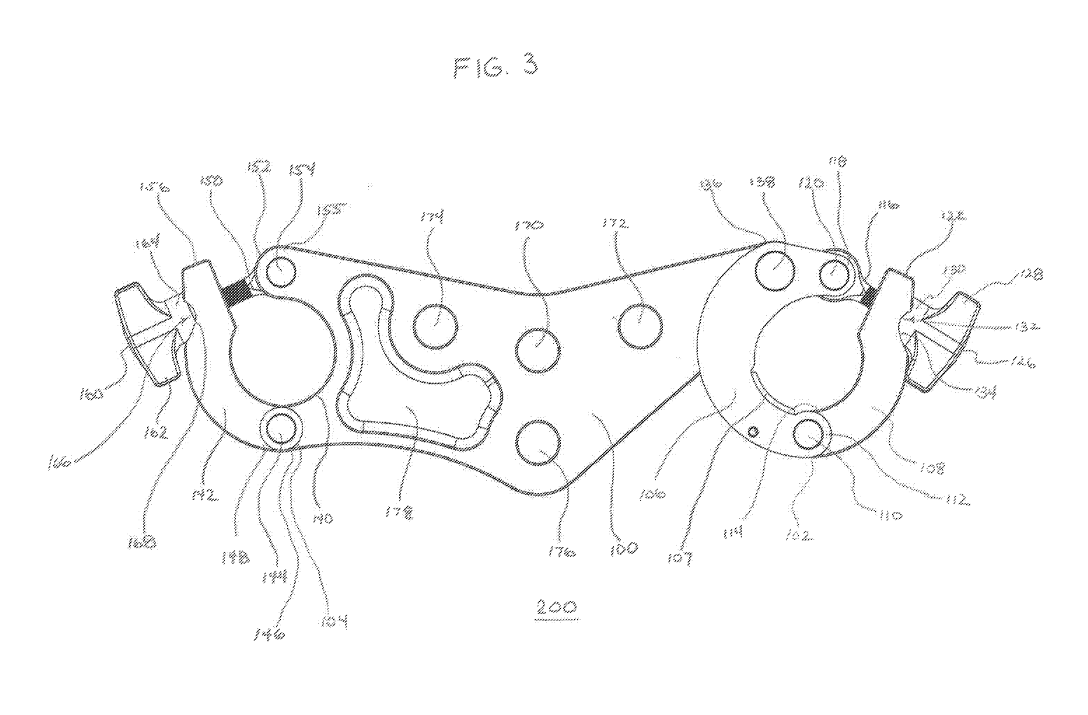

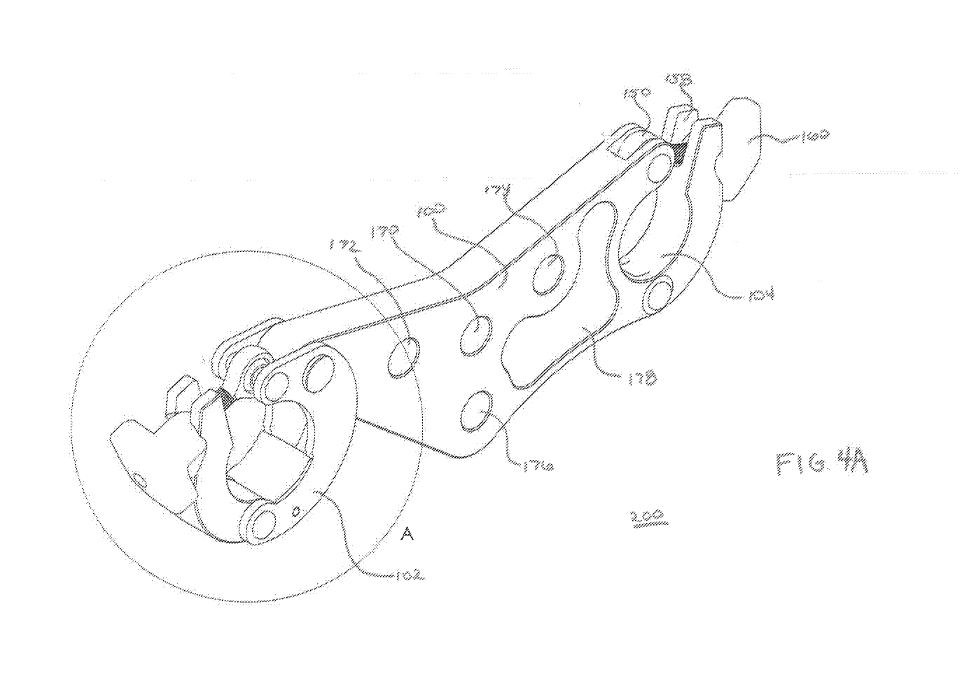

As seen more easily in FIGS. 3 and 4B, first swivel eye-bolt 116 is secured to the proximal end 118 of first saddle 106 through the eye of the first swivel eye-bolt 116 using first eye-bolt post 120. First eye-bolt post 120 extends through the proximal end 118 of first saddle 106 and the eye of the first eye-bolt post 120 in a manner so as to allow the first swivel eye-bolt 116 to swivel relative to first saddle 106. First swivel eye-bolt 116 preferably has a threaded stem surface.

Referring to FIG. 4B, formed in the distal end 122 of first clamp 108 is first forked slot 124 which is sized so as to receive the stem of first swivel eye-bolt 116 when the stem of first swivel eye-bolt 116 is swiveled toward the distal end 122 of first clamp 108.

First wing nut 126 has a winged head 128 and a hollow stem 130. Hollow stem 130 is threaded on the inner surface and sized so as to receive the threads of first swivel eye-bolt 116.

Adjacent first forked slot 124, and formed into the outer edge of first clamp 108, is first recessed nest 132, which is sized so as to receive the outer portion of hollow stem 130 of first wing nut 126.

As shown in FIGS. 4A, 4B, and 6, when first swivel eye-bolt 116 is rotated into position so that its stem is received within first forked slot 124, and the hollow stem 130 of first wing nut 126 receives the threads of first swivel eye-bolt 116, then first wing nut 126 may be tightened onto first swivel eye-bolt 116 until first wing nut 126 engages first recessed nest 132. As first wing nut 126 continues to be tightened, further engagement with first recessed nest 132 urges the distal end 122 of first clamp 108 toward the proximal end 118 of first saddle 106, tightening the interior generally circular perimeter substantially defined by the inner surfaces of first clamp 108 and first saddle 106, which swivel relative to each other around first clamp post 110.

Referring to FIGS. 1-3 and 4B, first relief 134 is formed in first clamp 108 proximate to first recessed nest 132 so as to permit the head 128 of first wing nut 126 to be twisted so as to tighten or loosen it without interference from first clamp 108.

First shoulder 136 of truss pick body 100 is located near one lateral end of the body 100. The adjustable first saddle and clamp assembly 102 is attached to the first shoulder 136 of body 100 using adjustable saddle post 138. The first saddle 106 may partially straddle truss pick body 100 including first shoulder 136. The adjustable saddle post 138 extends through the proximal end 118 of first saddle 106 and the first shoulder 136 of truss pick body 100, and is sized so as to permit the adjustable first saddle and clamp assembly 102 to swivel outwardly away from, and inwardly toward, the truss pick body 100.

Referring to FIGS. 1-3 and 4A, the stationary second saddle and clamp assembly 104 includes a second saddle 140 that is generally semicircular in profile, as defined by its inner surface. Second saddle 140 is connected to second clamp 142 by second clamp post 144 near the distal end 146 of second saddle 140 and the proximal end 148 of second clamp 142. In the illustrated embodiment, second saddle 140 is fixedly attached to, and preferably is integral with truss pick body 100. Second clamp 142 is also generally semi-circular in profile, as defined by its inner surface. Second clamp post 144 is sized in a manner to permit second clamp 142 to swivel relative to second saddle 140, and, in the illustrated embodiment, extends through the distal end 146 of second saddle 140 as well as the proximal end 148 of second clamp 142, securing them in a swiveling manner.

Second swivel eye-bolt 150 is attached to the proximal end 152 of second saddle 140 through the eye of the second swivel eye-bolt 150 using second eye-bolt post 154. Second eye-bolt post 154 extends through the proximal end 152 of second saddle 140 and the eye of the second swivel eye-bolt 150 so as to allow second swivel eye-bolt 150 to swivel relative to second saddle 140. Preferably, in the embodiment illustrated in FIGS. 1-3 and 4A, the proximal end 152 of second saddle 140 forms the second shoulder 155 of truss pick body 100 and is integral with it. Second swivel eye-bolt 150 includes a threaded surface on its stem. Second shoulder 155 is located laterally opposite first shoulder 136 on truss pick body 100.

The distal end 156 of second clamp 142 includes second forked slot 158 sized in a manner so it may receive the stem of second swivel eye-bolt 150 when the stem of second swivel eye-bolt 150 is swiveled toward the distal end 156 of second clamp 142.

Second wing nut 160 has a winged head 162 and a hollow stem 164. Hollow stem 164 has an interior that is threaded and sized to receive the threads on the stem of second swivel eye-bolt 150.

Proximate to second forked slot 158 and formed into the outer edge of second clamp 142 is second recessed nest 166. Second recessed nest 166 is sized so as to accommodate the outer portion of hollow stem 164 of second wing nut 160. When second wing nut 160 is rotated, the threads on the interior of hollow stem 164 engage the threads on the surface of the stem of second swivel eye-bolt 150, causing the second wing nut 160 to advance or retreat along the stem of second swivel eye-bolt 150.

When second swivel eye-bolt 150 is swiveled so that its stem is received within second forked slot 158, second wing nut 160 may be caused to engage second swivel eye-bolt 150, and may be twisted in a manner to advance the second wing nut 160 on the stem of second swivel eye-bolt 150 until it engages second recessed nest 166. Advancement (tightening) of second wing nut 160 further engages second recessed nest 166, urging the distal end 156 of second clamp 142 toward the proximal end 152 of second saddle 140, reducing the interior generally circular perimeter substantially defined by the inner surface of second clamp 142 and second saddle 140, as second clamp 142 is caused to rotate toward second saddle 140 around second clamp post 144.

Second relief 168 is provided in second clamp 142 near second recessed nest 166 to permit the winged head 162 of second wing nut 160 to be twisted without interference from second clamp 142.

Central suspension aperture 170 may be formed through the truss pick body 100 near the center between first shoulder 136 and second shoulder 155. Central suspension aperture 170 may be used to directly or indirectly attach a tension member (not illustrated and not part of the invention) for suspending the adjustable truss pick 200 from a fixture, such a as a permanent fixture, for example, a ceiling support structure.

First lateral suspension aperture 172 and second lateral suspension aperture 174 may likewise be formed through the body 100 on either side or both sides of central suspension aperture 170. The first and second lateral suspension apertures 172 and 174 are also provided for direct or indirect attachment of a tension member, and may be desirable if attachment to more than one tension member is desired, or if attachment to an off-center aperture is desired, for example, if an unbalanced load is being suspended. The availability of multiple suspension apertures 170, 172, and 174 provides the ability of an erector of rigging to utilize “bridle” rigging, providing multiple attachment points for tension members in order to stabilize a load supported by the rigging.

Bottom suspension aperture 176 may be provided for suspending a load directly or indirectly from the truss pick body 100, for example, by directly or indirectly attaching a tension member to the bottom suspension aperture 176 and suspending a load directly or indirectly from that tension member.

Weight relief 178 may be formed in the body 100 to promote balance or reduce weight in the adjustable truss pick 200.

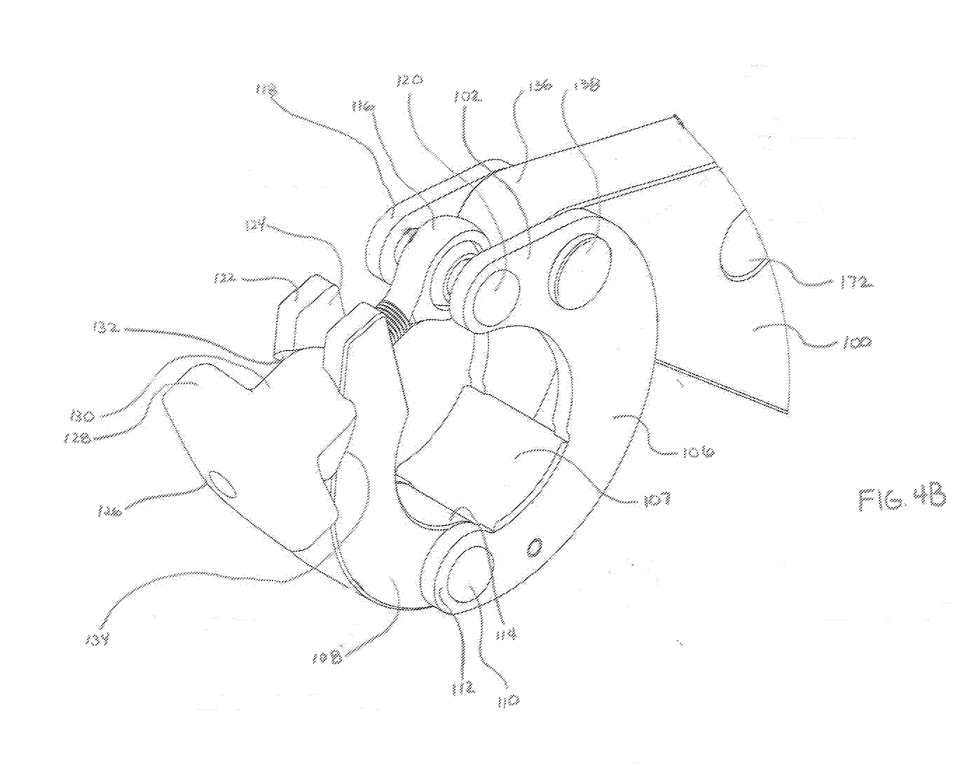

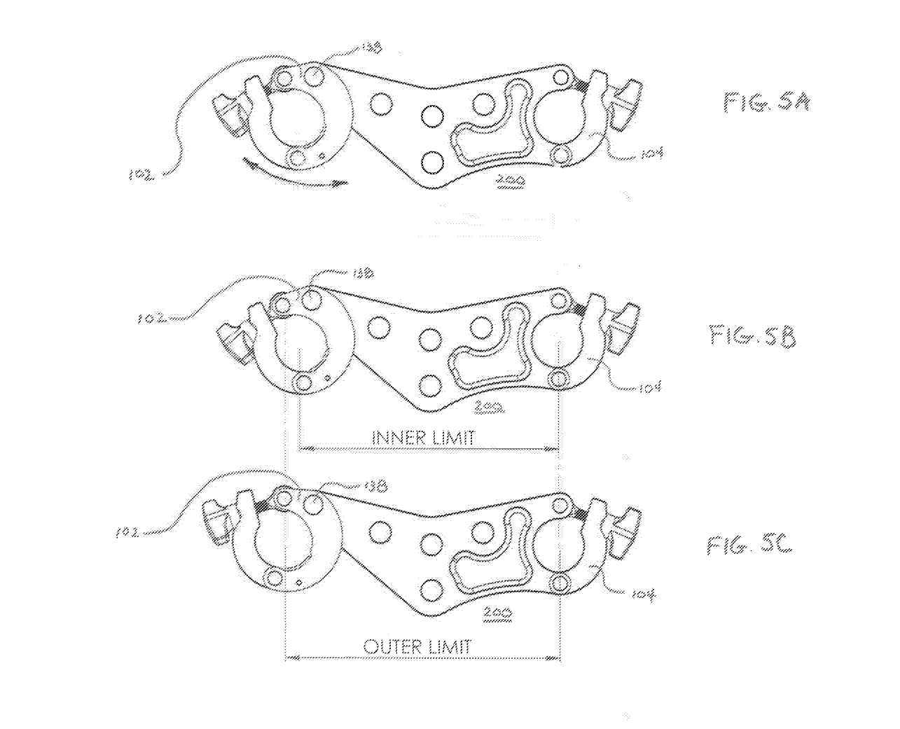

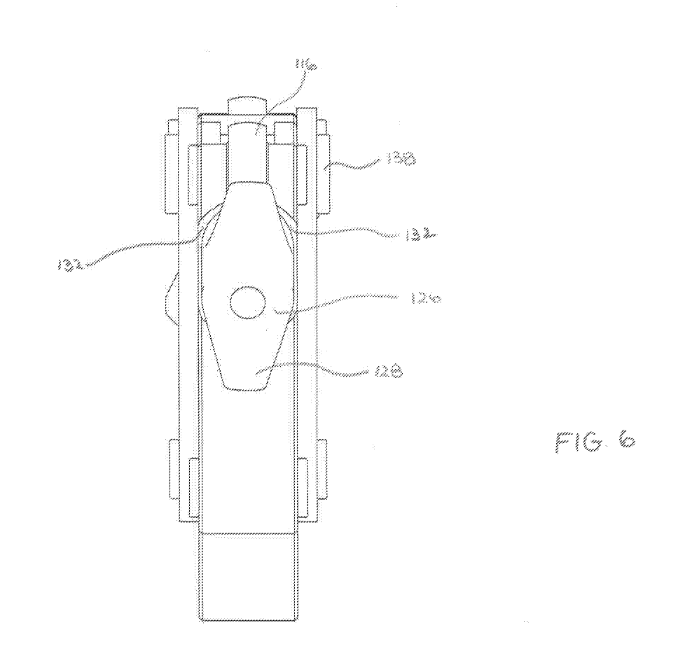

Referring to FIGS. 5A-5C, a comparison, in particular, of FIG. 5B to FIG. 5C illustrates how swiveling the adjustable first saddle and clamp assembly 102 provides adjustability of the distance between the invention's attachment portions, namely, stationary second saddle and clamp assembly 104 (which may be attached to one truss chord of a unit of truss) and adjustable first saddle and clamp assembly 102 (which may be attached to a second parallel adjacent truss chord from the same unit of truss). When adjustable first saddle and clamp assembly 102 is swiveled toward the truss pick body 100, the distance between the locations attached to the two truss chords reaches an inner limit. Conversely, if adjustable first saddle and clamp assembly 102 is swiveled away from the truss pick body 100, the distance between the locations attached to the two truss chords reaches an outer limit. Comparing FIG. 5B to FIG. 5C, the difference between the inner limit and the outer limit illustrates the amount of adjustability achieved by the adjustable truss pick invention 200.

In operation, referring to the illustrations, the adjustable truss pick 200 works as follows.

The adjustable first saddle and clamp assembly 102 may be opened. This is done by twisting first wing nut 126 so it retreats (loosens) along the threaded stem of first swivel eye-bolt 116 and no longer resides in first recessed nest 132. First swivel eye-bolt 116 is then free to swivel upwardly out of first forked slot 124 so that first swivel eye-bolt 116 no longer engages first clamp 108. First clamp 108 then may be swiveled outwardly away from first saddle 106 so that the adjustable first saddle and clamp assembly 102 is open to accept a truss chord of a unit of truss.

Similarly, stationary second saddle and clamp assembly 104 may be placed in an open position. Second wing nut 160 may be twisted so that it retreats along the threaded stem of second swivel eye-bolt 150 until it no longer resides in second recessed nest 166. This permits second swivel eye-bolt 150 to swivel upwardly out of the second forked slot 158 so that second swivel eye-bolt 150 no longer engages second clamp 142. Second clamp 142 may then be swiveled outwardly away from second saddle 140. Stationary second saddle and clamp assembly 104 may then be opened to accept another truss chord from the same unit of truss as previously described.

A truss chord of a unit of truss may then be placed in the now open second stationary saddle and clamp assembly 104. The truss chord fits in the gap between the second saddle 140 and the second clamp 142. Second clamp 142 is then swiveled inwardly toward second saddle 140 until second clamp 142 abuts the truss chord. Second swivel eye-bolt 150 is swiveled downwardly until it engages second forked slot 158 of second clamp 142. Second wing nut 160 is twisted so that it advances (tightens) along the stem of second swivel eye-bolt 150, causing the stem 164 of second wing nut 160 to engaged second recessed nest 166, urging second clamp 142 to swivel toward second saddle 140, and causing second clamp 142 to tighten against the truss chord. When second wing nut 160 is sufficiently tightened, the truss chord is fully secured in the stationary second saddle and clamp assembly 104 between second clamp 142 and second saddle 140. The edges of second recessed nest 166 in this condition engage the stem 164 of second wing nut 160 which, because it is engaged with second swivel eye-bolt 150, prevents second swivel eye-bolt 150 from becoming disengaged from second forked slot 158, thus preventing the stationary second saddle and clamp assembly 104 from being disengaged from the truss chord, until such disengagement is desired. In that event, the second wing nut 160 may then be twisted to intentionally loosen it, and the stationary second saddle and clamp assembly 104 may be opened as previously described. The truss chord may then be removed.

With the first truss chord of a unit of truss already securely attached via the stationary second saddle and clamp assembly 104, another adjacent parallel truss chord from the same unit of truss may then be placed in the now-open adjustable first saddle and clamp assembly 102, fitting the truss chord in the gap between the first saddle 106 and the first clamp 108. Because this truss attachment location is not stationary, but rather is adjustable (see, in particular, FIGS. 5A, 5B, and 5C), first saddle 106 is swiveled relative to truss pick body 100 around adjustable saddle post 138 until first saddle 106 abuts the truss chord. This swiveling of the first saddle 106 corrects for width deviation issues as previously described that might arise vis-a-vis the two adjacent parallel truss chords from the same truss unit being attached to adjustable truss pick 200, and that might require adjustment to achieve a proper and secure fit between the adjustable truss pick 200 and both truss chords of the same unit of truss.

First clamp 108 is then swiveled inwardly toward first saddle 106 until first clamp 108 abuts the truss chord, which at this point should rest on first saddle support 107. First swivel eye-bolt 116 is swiveled downward to engage first forked slot 124 of first clamp 108. First wing nut 126 is twisted so that it advances and tightens on the stem of first swivel eye-bolt 116. This causes the stem 130 of first wing nut 126 to engage first recessed nest 132 of first clamp 108, which, in turn, urges first clamp 108 to swivel toward first saddle 106. This causes first clamp 108 to tighten, securing the truss chord between first clamp 108 and first saddle 106. As tightening of first wing nut 126 continues, the tightening of first clamp 108 against the truss chord urges the truss chord to move against first saddle 106, causing first saddle 106 to “self-adjust”—to move to correct any remaining minor truss chord width issues—by swiveling about adjustable saddle post 138. A precise fit to the width between the two truss chords is thereby achieved, overcoming the problems discussed above relating to ordinary, rigid, prior art truss picks.

As first wing nut 126 is sufficiently tightened, the truss chord is fully secured in the adjustable first saddle and clamp assembly 102 between first saddle 106 and first clamp 108 in a heretofore difficult to achieve precise fit, a distinct benefit of this invention. The edges of first recessed nest 132 at this stage engage the stem 130 of first wing nut 126, preventing first swivel eye-bolt 116 from disengaging from first forked slot 124. This prevents the adjustable first saddle and clamp assembly 102 from becoming disengaged from the truss chord secured there, until such time as disengagement is desired. At that time, first wing nut 126 is loosened, first swivel eye-bolt 116 is swiveled upwardly, and the adjustable first saddle and clamp assembly 102 may be opened as previously described, allowing the truss chord to be removed.

Adjustable truss pick 200 may be suspended from a permanent fixture using one or more vertical tension members suspended from the permanent fixture, and attached directly or indirectly to truss pick body 100 using one or more of the suspension apertures in the body 100, namely the central suspension aperture 170, or the first or second lateral suspension apertures 172 and 174, in the manners previously described.

While the invention has been described with reference to specific embodiments and features, it will be appreciated by skilled practitioners that modifications and changes may be made without departing from the scope of the invention. It is to be recognized that optimal dimensional relationships for the components of the present invention may include variations in size, materials, shape, form, and manner of operation. In particular, while the illustrated embodiment discussed an embodiment of the invention having one adjustable saddle and clamp assembly 102 attached to the body so that it may swivel, and one stationary saddle and clamp assembly 104 attached to the body so that it does not swivel, skilled practitioners will recognize that the stationary saddle and clamp assembly 104 may be replaced by a second adjustable saddle and clamp assembly similar to the first 102, that also swivels, without departing from the scope of the invention.

What is claimed is:

1. An adjustable truss pick for hanging tubular space frame truss having a plurality of longitudinal tubular truss chords interconnected by tubular webbing elements, the adjustable truss pick comprising:
(A) a truss pick body having a first shoulder and a second shoulder;
(B) an adjustable first saddle and clamp assembly attached to the first shoulder of the truss pick body using a first adjustable saddle post so as to permit the first saddle and clamp assembly to swivel at least partially relative to the truss pick body around the first adjustable saddle post;
(C) a second saddle and clamp assembly located on the truss pick body at the second shoulder; and
(D) one or more suspension apertures in the body.

2. The adjustable truss spick of claim 1, further comprising:
(A) the first saddle and clamp assembly including:
(1) a first saddle having a proximal end and a distal end; and
(2) a first clamp having a proximal end and a distal end, wherein the proximal end of the first clamp is attached to the distal end of the first saddle using a first clamp post so as to permit the first clamp to swivel at least partially relative to the first saddle around the first clamp post;
(B) the second saddle and clamp assembly including:
(1) a second saddle having a proximal end and a distal end; and
(2) a second clamp having a proximal end and a distal end, wherein the proximal end of the second clamp is attached to the distal end of the second saddle using a second clamp post so as to permit the second clamp to swivel at least partially relative to the second saddle around the second clamp post.

3. The adjustable truss pick of claim 3, further comprising:
(A) the distal end of the first clamp having a first forked slot formed therein;
(B) the distal end of the second clamp having a second forked slot formed therein;
(C) the proximal end of the first saddle being attached to a first swivel eye-bolt having an eye and a stem using a first eye-bolt post through the proximal end of the first saddle and the eye of the first swivel eye-bolt so as to permit the stem of the first swivel eye-bolt to swivel at least partially relative to the proximal end of the saddle around the first eye-bolt post;
(D) the proximal end of the second saddle being attached to a second swivel eye-bolt having an eye and a stem using a second eye-bolt post through the proximal end of the second saddle and the eye of the second swivel eye-bolt so as to permit the stem of the second swivel eye-bolt to swivel at least partially relative to the proximal end of the second saddle around the second eye-bolt post;
(E) the first forked slot being sized so as to receive the stem of the first swivel eye-bolt; and
(F) the second forked slot being sized so as to receive the stem of the second swivel eye-bolt.

4. The adjustable truss pick of claim 4, further comprising;
(A) a first wing nut including a stem and a winged head, wherein the stem of the first wing nut is engageable with the stem of the first swivel eye-bolt; and
(B) a second wing nut including a stem and a winged head, wherein the stem of the second wing nut is engageable with the stem of the second wing nut.

5. The adjustable truss pick of claim 4, wherein:
(A) the stem of the first wing nut is engageable with the stem of the first swivel eye-bolt in a threaded connection; and
(B) the stem of the second wing nut is engageable with the stem of the second swivel eye-bolt in a threaded connection.

6. The adjustable truss pick of claim 5, wherein:
(A) when the first wing nut is threadedly engaged with the stem of the first swivel eye-bolt:
(1) the threaded connection between the first wing nut and the stem of the first swivel eye-bolt may be tightened by rotating, in a first direction, the winged head of the first wing nut; and
(2) the threaded connection between the first wing nut and the stem of the first swivel eye-bolt may be loosened by rotating, in a second direction different from the first direction, the winged head of the first wing nut; and
(B) when the second wing nut is threadedly engaged with the stem of the second swivel eye-bolt:
(1) the threaded connection between the second wing nut and the stem of the second swivel eye-bolt may be tightened by rotating, in a first direction, the winged head of the second wing nut; and
(2) the threaded connection between the second wing nut and the stem of the second swivel eye-bolt may be loosened by rotating, in a second direction, the winged head of the second wing nut.

7. The adjustable truss pick of claim 6, wherein:
(A) when the stem of the first swivel eye-bolt is received in the first forked slot, and the first wing nut is threadedly engaged with the stem of the first swivel eye-bolt, and the first wing nut is rotated in the first direction causing the threaded engagement between the first wing nut and the stem of the first swivel eye-bolt to tighten, then:
(1) the first wing nut is caused to initiate engagement with the distal end of the first clamp proximate to the first forked slot; and
(2) when the first wing nut initiates engagement with the distal end of the first clamp, and when the first wing nut is rotated further in the first direction, then the distal end of the first clamp is caused by the first wing nut to move toward the proximal end of the first saddle and the first clamp is caused to swivel at least partially relative to the first saddle around the first saddle post toward the first saddle, causing the adjustable first saddle and clamp assembly to tighten.

8. The adjustable truss pick of claim 7, wherein:
(A) when the stem of the second swivel eye-bolt is received in the second forked slot, and the second wing nut is threadedly engaged with the stem of the second swivel eye-bolt, and the second wing nut is rotated in the first direction causing the threaded engagement between the second wing nut and the stem of the second swivel eye-bolt to tighten, then:
(1) the second wind nut is caused to initiate engagement with the distal end of the second clamp proximate to the second forked slot; and
(2) when the second wing nut initiates engagement with the distal end of the second clamp, and when the second wing nut is rotated further in the first direction, then the distal end of the second clamp is caused by the second wing nut to move toward the proximal end of the second saddle, and the second clamp is caused to swivel at least partially selective to the second saddle around the second saddle post toward the second saddle, causing the adjustable second saddle and clamp assembly to tighten.

9. The adjustable truss pick of claim 8, wherein:
(A) when the tubular space frame truss having a plurality of longitudinal tubular truss chords is mounted on the adjustable truss pick so that a first tubular truss chord is positioned within the first saddle and clamp assembly, and a second tubular truss chord that is different from the first tubular truss chord is positioned within the second saddle and clamp assembly; and
(B) when the first saddle and clamp assembly is tightened around the first tubular truss chord, and the second saddle and clamp assembly is tightened around the second tubular truss chord;
(C) then the first saddle and clamp assembly is caused to swivel partially relative to the truss pick body around the first adjustable saddle post, with the result the distance between the first saddle and clamp assembly and the second saddle and clamp assembly of the adjustable truss pick changes to accommodate the distance between the first tubular truss chord and the second tubular truss chord mounted on the adjustable truss pick.

10. The adjustable truss pick of claim 9, wherein:
the second saddle is integral with the truss pick body, and the second saddle is stationary relative to the truss pick body.

11. The adjustable truss pick of claim 8, wherein:
(A) the second saddle and clamp assembly is an adjustable second saddle and clamp assembly attached to the second shoulder of the truss pick body using a second adjustable saddle post so as to permit the second saddle and clamp assembly to swivel at least partially relative to the truss pick body around the second adjustable saddle post.

12. The adjustable truss pick of claim 11, wherein:
(A) when the tubular space frame truss having a plurality of longitudinal tubular truss chords is mounted on the adjustable truss pick so that a first tubular truss chord is positioned within the first saddle and clamp assembly, and a second tubular truss chord that is different from the first tubular truss chord is positioned within the second saddle and clamp assembly; and
(B) when the first saddle and clamp assembly is tightened around the first tubular truss chord, and the second saddle and clamp assembly is tightened around the second tubular truss chord;
(C) then the first saddle and clamp assembly is caused to swivel partially relative to the truss pick body around the first adjustable saddle post, and the second saddle and clamp assembly is caused to swivel partially relative to the truss pick body around the second adjustable saddle post, with the result the distance between the first saddle and clamp assembly and the second saddle and clamp assembly of the adjustable truss pick changes to accommodate the distance between the first tubular truss chord and the second tubular truss chord mounted on the adjustable truss pick.
